(19) United States
(12) Patent Application Publication
(10) Pub. No.: US 2017/0323066 A1
(43) Pub. Date: Nov. 9, 2017

(54) HEALTHCARE PROVISION SYSTEMS AND METHODS

(71) Applicant: SHERPAA HEALTH, INC., New York, NY (US)

(72) Inventor: Jay Parkinson, Brooklyn, NY (US)

(21) Appl. No.: 15/588,255

(22) Filed: May 5, 2017

Related U.S. Application Data
(60) Provisional application No. 62/332,587, filed on May 6, 2016.

(51) Int. Cl. G06F 19/00; G06F 21/62

(52) U.S. Cl. CPC G06F 19/345; G06F 19/3406; G06F 21/6245

(57) ABSTRACT

Aspects and embodiments are generally directed to systems and methods for generating and organizing the development of healthcare cases between at least a patient device and a physician device. In one example, a method includes receiving a healthcare request from a patient device, the healthcare request being associated with a healthcare case and including a request for a medical diagnosis, assigning the healthcare case to a physician, routing the healthcare request to a physician device of the physician, receiving a response to the healthcare request from the physician device, the response including at least a healthcare module that specifies one or more healthcare service operations that require approval by the patient device prior to execution, transmitting the response including the healthcare module to the patient device, and holding the one or more healthcare service operations in abeyance until the approval is received from the patient device.

### CROSS-REFERENCE TO RELATED APPLICATIONS

This application claims priority under 35 U.S.C. §119(e) to U.S. Provisional Application Ser. No. 62/332,587 titled “HEALTHCARE PROVISION SYSTEMS AND METHODS,” filed on May 6, 2016, which is hereby incorporated herein by reference in its entirety.

### BACKGROUND

Conventional healthcare services generally look the same around the world. When struck with an illness, a patient must schedule an appointment with a physician, or travel to an immediate care facility. In either case, the patient is left waiting for a physician to become available and is typically limited to a ten or fifteen minute conversation with the physician. If the patient requires lab testing, expert examination, or authorization for medical treatment (e.g., a prescription or referral), the physician must then take further steps to ensure these tasks are performed. For instance, once an appropriate medication has been selected, the physician must prepare and hand a prescription to the patient for fulfillment at a pharmacy of their choice. E-prescribing is now also available, where physicians electronically submit the prescription to a fulfillment service. Similar procedures exist for placing referrals and requesting laboratory testing. In either scenario, the patient generally does not have the time or opportunity to learn about the medication, the referred physician, and/or the laboratory testing requested. As such, conventional health care delivery can be inefficient, costly, and stressful for those involved. In some instances, these drawbacks may even discourage patients from seeking necessary medical attention.

### SUMMARY

Aspects and embodiments discussed herein provide systems and methods for providing efficient, convenient, and simplified healthcare and related services. In particular, aspects and embodiments provide healthcare provision systems and related methods for generating and organizing the distributed development of healthcare cases between one or more patient devices, physician devices, and additional healthcare service providers. Examples of the healthcare provision systems described herein facilitate the interaction of a patient in healthcare processes from which they have been historically excluded. Unlike conventional healthcare systems, which often relay on the centralized and unilateral control of a physician, such examples allow greater and more efficient patient access to information, greater patient control, and increased accuracy and security of healthcare information. Moreover, certain aspects and examples include app systems, applications, and tools that provide interactive graphical user interfaces that allow a patient to access, review, control, and interact with healthcare service operations that conventional healthcare systems typically withhold. Accordingly, in addition to improving the executional efficiency of conventional healthcare systems, aspects and embodiments discussed herein provide distributed functionality that is not currently available in conventional healthcare systems.

According to an aspect, provided is a method of organizing the development of healthcare cases between at least a patient device and a physician device. In one example, the method comprises receiving a healthcare request from a patient device, the healthcare request being associated with a healthcare case and including a request for a medical diagnosis, assigning the healthcare case to at least a first physician, routing the healthcare request to a physician device of the at least a first physician, the healthcare request being displayable at the physician device, receiving a first response to the healthcare request from the physician device, the first response being associated with the healthcare case and including at least a healthcare module, where the healthcare module specifies one or more healthcare service operations that require approval by the patient device prior to execution, transmitting the first response including the healthcare module to the patient device, and holding the one or more healthcare service operations in abeyance until the approval is received from the patient device.

According to various examples, the method further comprises receiving the approval from the patient device and executing the one or more healthcare service operations in response to receive the approval. In certain examples, the one or more healthcare service operations include at least one of a distribution of a prescription, a distribution of a referral, or a distribution of a test order. In various examples, at least the healthcare module is displayable in a graphical user interface at the patient device including one or more user selections, and activation of the one or more user selections provides the approval. According to further examples, the one or more user selections include an APPROVE indicator and a DENY indicator, and activation of the APPROVE indicator provides the approval.

In various examples, the healthcare request further includes a first timestamp indicative of a time of generation thereof at the patient device, the method further comprising indexing and storing the healthcare request based on the healthcare case and the first timestamp. In some examples, the first response further includes a second timestamp indicative of a time of generation thereof at the physician device, the method further comprising indexing and storing the first response based on the healthcare case and the second timestamp, the first response being chronologically indexed with the healthcare request. In further examples, the method further comprises providing a status of the healthcare case based at least in part on the most recent chronologically indexed healthcare request or first response.

According to various examples, assigning the healthcare case to the at least a first physician includes assigning the healthcare case to a group of physicians, and routing the healthcare request to a physician device of the at least a first physician includes routing the healthcare request to a physician device of each physician within the group of physicians.

According to an aspect, provided is a method of developing a healthcare case. In one example, the method comprises generating a healthcare request at a patient device, the healthcare request being associated with a healthcare case and including a request for a medical diagnosis; transmitting the healthcare request to a healthcare provision service, receiving a response to the healthcare request from the healthcare provision service, the response being associated with the healthcare case and including a healthcare module, where the healthcare module specifies one or more healthcare service operations that require approval by the patient device prior to execution, displaying at least the healthcare module in a graphical user interface at the patient device, the graphical user interface including one or more user selections the activation of which provides the approval, and receiving activation of the one or more user selections.

According to certain examples, the one or more user selections include an APPROVE indicator and a DENY indicator, and activation of the APPROVE indicator provides the approval. In various examples, the one or more healthcare service operations include at least one of a distribution of a prescription, a distribution of a referral, or a distribution of a test order. In one or more examples, the healthcare request includes at least one message having characteristics of a medical condition, and the response includes at least one question or diagnosis regarding the medical condition. In one particular example, the response includes a series of structured questions configured to solicit targeted details from the patient. According to certain examples, the method further comprises comprising generating and displaying one or more alerts at the patient device responsive to receiving the response, the one or more alerts indicating the inclusion of the module within the response.

According to another aspect, provided is a healthcare provision system to execute a healthcare provision service for organizing the development of healthcare cases between at least a patient device and a physician device. In one example, the healthcare provision system comprises a system interface configured to receive: a healthcare request from a patient device, the healthcare request being associated with a healthcare case and including a request for a medical diagnosis, and a response to the healthcare request from a physician device of at least a first physician, the response being associated with the healthcare case and including a healthcare module. The healthcare provision system may further comprise a database to index and store the healthcare request and the response based at least in part on a respective timestamp thereof and the healthcare case, and at least one processor operatively connected to a memory, the system interface, and the database, the processor when executing configured to: assign the healthcare case to the at least a first physician, route the healthcare request to the physician device of the at least a first physician, the healthcare request being displayable at the physician device, transmit the response and the healthcare module to the patient device, where the healthcare module specifies one or more healthcare service operations that require approval by the patient device prior to execution, and hold the one or more healthcare service operations in abeyance until the approval is received from the patient device.

According to various examples, the system interface is further configured to receive the approval from the patient device, and the at least one processor is further configured to execute the one or more healthcare service operations. In at least one example, the healthcare module is displayable in a graphical user interface at the patient device including one or more user selections, and the activation of the one or more user selections provides the approval. In a further example, the one or more user selections includes an APPROVE indicator and a DENY indicator, and activation of the APPROVE indicator provides the approval. According to various examples, in assigning the healthcare case to at least a first physician the processor is configured to assign the healthcare case to a group of physicians, and in routing the healthcare request to the physician device of the at least a first physician the processor is further configured to route the healthcare request to a physician device of each physician within the group of physicians.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment. Various aspects and embodiments described herein may include means for performing any of the described methods or functions.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram of a healthcare provision system according to various examples described herein;

FIG. 2 is an illustration of a graphical user interface for a healthcare request as displayed at a patient device, according to various examples described herein;

FIG. 3 is an illustration of a graphical user interface for a response as displayed at a physician device, according to various examples described herein;

FIG. 4 is an illustration of a graphical user interface for an alert as displayed at a patient device, according to various examples described herein;

FIG. 5 is an illustration of a graphical user interface for a healthcare module as displayed at a patient device, according to various examples described herein;

FIG. 6 is an example of indexed entries within a database of the healthcare provision system illustrated in FIG. 1, according to various examples described herein;

FIG. 7 is an illustration of a graphical user interface for a healthcare case status as displayed at a patient device, according to various examples described herein;

FIG. 8A-8B is a process flow of a method for organizing the development of a healthcare case, according to various examples described herein;

FIG. 9 is a process flow of a method for developing a healthcare case, according to various examples described herein; and

FIG. 10 is a block diagram of a computer system with which various aspects and embodiments may be practiced, according to various examples described herein.

### DETAILED DESCRIPTION

Aspects and examples discussed herein provide systems and methods for providing efficient, convenient, and simplified healthcare and related services. In particular, aspects and embodiments provide healthcare provision systems and related methods for generating and organizing the distributed development of healthcare cases between one or more patient devices, physician devices, and additional healthcare service providers. Unlike conventional healthcare delivery which often involves centralized unilateral physician discretion and control, aspects and embodiments facilitate greater and more efficient patient access to information, greater patient control, and increased accuracy and security of healthcare information. Moreover, distributed review by the healthcare provision system augments the executional efficiency of the healthcare provision system itself and allows the generation of healthcare analytics and metrics to further improve the operation of the healthcare provision system and the services provided to the associated users.

In certain examples, the healthcare provision systems discussed herein includes app systems, applications, and tools configured to facilitate the exchange of data between users, such as patients, physicians, medical service providers (e.g., a testing laboratory or imaging provider), and one or more fulfillment service provides (e.g., a pharmacy). The described app systems, applications, and tools provide interactive graphical user interfaces that allow a patient to access, review, and control information and operations that conventional healthcare systems typically withhold. Specifically, the described healthcare provision systems may include a healthcare provision service configured to distribute and exchange data with one or more dynamic healthcare applications executing on one or more computing devices. Exchanged data may include communications regarding medical issues and conditions, diagnoses, consultations, referrals, test orders, laboratory orders, imaging orders, laboratory results, prescriptions, and any other communication that would typically occur in the presence of a physician at an office or hospital. In specific examples, the data is arranged into a series of healthcare cases, each case having one or more messages (e.g., healthcare request or response) and one or more healthcare modules.

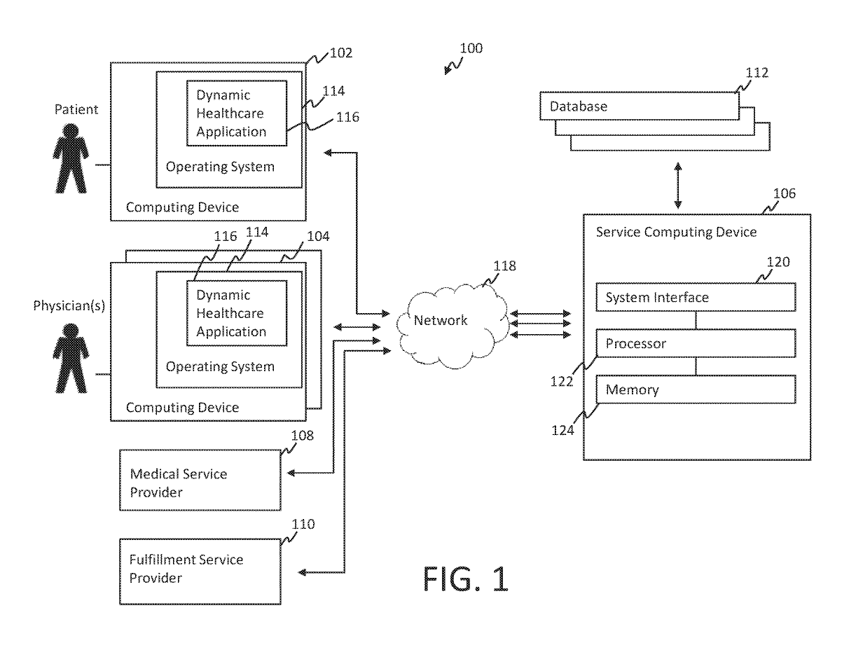

In various examples, healthcare cases may be generated through a user profile (e.g., patient profile or physician profile) of a dynamic healthcare application. Each case may include one or more healthcare requests, one or more responses to a healthcare request, and one or more healthcare modules. Components of each healthcare case may be timestamped, indexed, and accessible to users and participants within the healthcare provision system. Modules associated with each case provide for the approval or denial of one or more healthcare service operations to be performed within the case, such as transmission of a prescription to a fulfillment service, distribution of a request for laboratory testing, distribution of a request for imaging, or transmission of an expert referral. According to some embodiments, patients and physicians can access an application store for downloading or purchasing the dynamic healthcare application. Details of these aspects and embodiments, in addition to others, are further discussed below with reference to at least FIGS. 1-10. Accordingly, various aspects and embodiments improve the executional efficiency of conventional healthcare systems and offer important functionality such as greater access to information, greater user interaction, increased security and confidentiality, and greater control. These benefits are generally important to effective healthcare delivery.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

FIG. 1 is a block diagram of one example of a healthcare provision system 100 and service suitable for incorporation of various aspects of the present disclosure. In the shown example, the healthcare provision system 100 may include a healthcare provision service (“service”) executed on one or more service computing devices 106, at least one patient user device (“patient device”) 102, at least one physician user device (“patient device”) 104, one or more databases 112, and one or more network connections 118 between the service computing device 106, the patient device 102, and the physician device 104. As further shown, the system 100 may further include at least one medical service provider 108 and at least one fulfillment service provider 110 connected via the network connection 118 with at least the service computing device 106. For instance, each of the illustrated medical service provider 108 and at least one fulfillment service provider 110 may include a respective computing device, system, or network. As further discussed below, the healthcare provision service facilitates the distributed exchange of healthcare data between at least the patient device 102 and the physician device 104, the patient device 102 and medical service provider 108, the patient device 102 and the fulfillment service provider 110, and/or any other combination thereof. The service may further store the exchanged data, generate analytics and metrics, and provide an analysis of the exchanged data. In such a manner, the service may organize and manage the development of one or more healthcare cases associated with a particular patient.

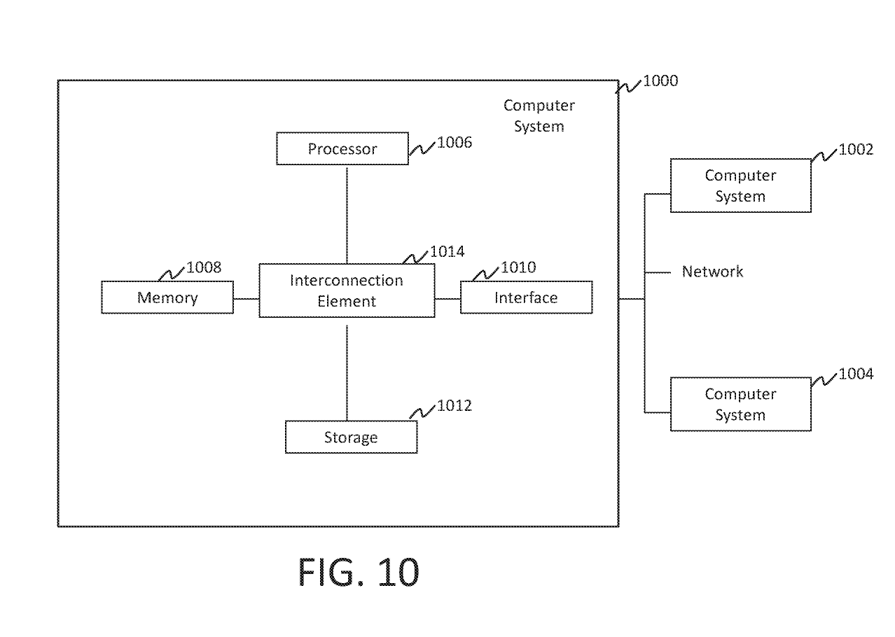

In various embodiments, the service may include one or more components, each of which may be implemented on one or more computer systems, such as the illustrated service computing device 106. Examples of computing systems are described below with reference to at least FIG. 10. For example, the system 100 may include a receiving component configured to receive healthcare data (e.g., data associated with a healthcare case) from the patient device 102, the physician device 104, the medical service provider 108, the fulfillment service provider 110, or any combination thereof, a transmission component configured to transmit healthcare data to the patient device 102, the physician device 104, the medical service provider 108, the fulfillment service provider 110, or any combination thereof, an analytics engine configured to analyze the exchanged healthcare data and provide one or more analytics and/or metrics, an indexing component configured to access, store, and read data from the database 112, and/or a healthcare module component configured to track the approval or denial of a healthcare module, hold a healthcare service operation of the healthcare module in abeyance, and execute the healthcare service operation.

The healthcare provision system 100 is shown as including at least one system interface 120, at least one processor 122, and a memory 124, configured to implement the service. However, in various arrangements, the service may be implemented on a distributed computer system using one or more communication networks (e.g., the Internet). For example, the service may include a webserver which is capable of serving as a front end to the service. In one implementation, the service is implemented in a cloud-based computing platform, such as the well-known EC2 platform available commercially from Amazon.com of Seattle, Wash. In certain embodiments, the database 112 may include a cloud database implemented by a cloud computing platform. For instance, the database 112 may include one or more cloud database instances provisioned among one or more cloud database providers. A cloud database service may control the underlying instances of the database, including an Application Programming Interface (API) that allows control regulation of the database instances. Other implementations are possible and are within the scope and spirit of the disclosure, and it is appreciated that other platforms may be used.

In various embodiments, the system interface 120 is configured to receive data, such as the healthcare data, from the patient device 102 and/or the physician device 104. As shown, the patient device 102 and/or the physician device 104 may include a computing device such as a cell phone, smart phone, PDA, tablet computer, laptop computer, desktop computer, or other computing device having an operating system 114. In certain embodiments, the exchanged healthcare data may include a healthcare request. In various embodiments a healthcare request may include a request for a medical diagnosis, a question about a medical condition, a description of a medical condition, or any other medical related inquiry from a patient. For instance, in one example a dynamic healthcare application 116 executing on the patient device 102 is capable of receiving a patient entry specifying specific symptoms that the patient is experiencing.

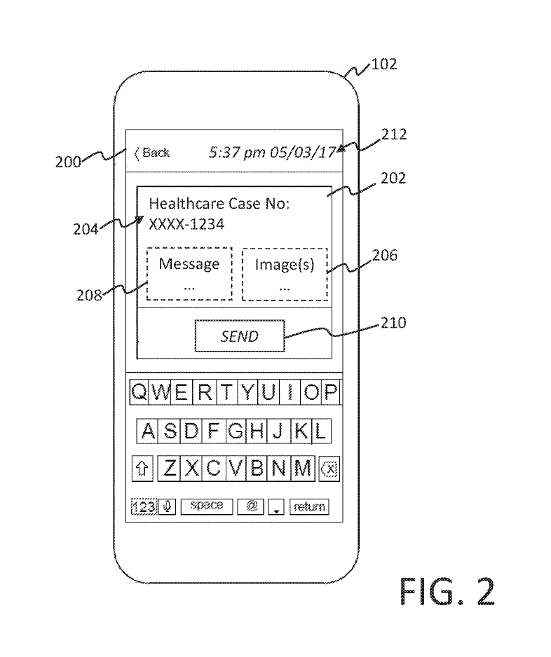

In various embodiments, the patient may generate a healthcare request by creating a healthcare case within the dynamic healthcare application 116. The healthcare case serves as a file by which transmitted messages and responses may be organized and categorized. Each healthcare request is associated with a new healthcare case or a pre-existing healthcare case. In certain other embodiments, healthcare cases may be automatically generated by the healthcare provision service in response to generation of a new healthcare request. In addition to healthcare requests, healthcare cases may include responses to healthcare requests and healthcare modules, each of which may also be generated within the dynamic healthcare application 116. In various examples, the dynamic healthcare application 116 executing on the patient device 102 generates a graphical user interface for the entry of a healthcare request. FIG. 2 illustrates one example of a graphical user interface 200 for a healthcare request 202 as displayed at a patient device 102.

As illustrated in FIG. 2, in certain examples the graphical user interface 200 includes a healthcare case identifier 204 associated with the healthcare case of the request 202. The dynamic healthcare application 116 may provide one or more predefined entries for the patient to select, and/or in various other examples, provide user tools to enter free-form information to define the healthcare request 202 within the graphical user interface 200. For instance, the graphical user interface 200 may include one or more text boxes for entering a message 208, one or more options for entering an image 206, or one or more options for attaching a video or voice recording (not illustrated). In various embodiments, the healthcare request 202 may invite a physician to provide a response to the healthcare request 202, such as a recommendation, a diagnosis, or a series of structured questions configured to solicit targeted details from the patient.

Once the healthcare request 202 has been generated by the patient device 102, and reviewed and or edited by the patient (e.g., the user of the patient device 102), the patient may select one or more options within the graphical user interface 200 to transmit the healthcare request 202 to the healthcare provision service via the network connection 118. In the example of FIG. 2, the patient device 102 is configured to transmit the healthcare request 202 responsive to activation of a send indicator 210 within the graphical user interface 200. The service may then route the healthcare request (e.g., healthcare request 202) to an assigned physician device, or the physician devices of an assigned group of physicians. For instance, the service may route the healthcare request 202 to the physician device 104 illustrated in FIG. 1. As further illustrated in FIG. 2, in certain examples the graphical user interface 200 may further include a timestamp 212 indicative of a time at which the healthcare request 202 is generated. The timestamp 212 of the healthcare request 202 may be used to index and store the healthcare request 202, as further discussed herein.

Returning to FIG. 1, once received by the healthcare provision service, the service indexes and stores the healthcare request. Healthcare requests may be stored and indexed based on the associated healthcare case and the associated timestamp (e.g., healthcare case ID 204 and timestamp 212 shown in FIG. 2). As discussed herein, in at least one example each healthcare request includes a message. Accordingly, in various embodiments each healthcare case may be composed of numerous messages. Timestamps associated with individual requests enable the service to track progression of the healthcare case and provide analysis, as further discussed herein. In various embodiments, each message may have a message state. For example, states may include “read”, “unread”, “responded to”, or “not responded to.” States may be provided with a healthcare request when routing that healthcare request to the physician device 104 to alert the assigned physician of the status of the healthcare request.

In certain embodiments, each healthcare case may be assigned to one or more physicians or one or more groups of physicians. Once assigned, the healthcare requests associated with that healthcare case are also assigned to that physician or group of physicians. As discussed herein, physicians may include any medical professional including but not limited to general practitioners, specialist medical practitioners, and any other medical professional who has a detailed knowledge of diseases and treatments. Healthcare cases may be assigned to one or more default physicians or may be assigned based on a comparison of a subject matter of the healthcare request and a specialization of the physician. In certain other examples, each subsequent request for a healthcare case may be assigned to the same physician (or group) as a previous healthcare request.

In certain embodiments, healthcare cases may be re-assigned, combined, split, and/or deleted depending on the situation. For instance, each assigned physician for a healthcare case may transfer the case to another physician and re-assign that healthcare case. Each healthcare request for a healthcare case is routed to the physician device(s) of the assigned physician (or group) as the healthcare request is received by the service. As shown in the example of FIG. 1, the physician device 104 may execute the dynamic healthcare application 116 which allows the physician to review and interact with the received healthcare request. For instance, the dynamic healthcare application 116 may provide a graphical user interface through which the physician device 104 may display the healthcare request to the assigned physician.

In various embodiments, receipt of a healthcare request at the physician device 104 may trigger an alert that an action is required. For instance, a graphical user interface displayed at the physician device 104 may display one or more pop-up notices or alerts indicating that a new healthcare request has been received at the physician device 104. In various embodiments, the physician device 104 (e.g., via the dynamic healthcare application 116), is configured to receive entry of one or more responses from the physician regarding the received healthcare request.

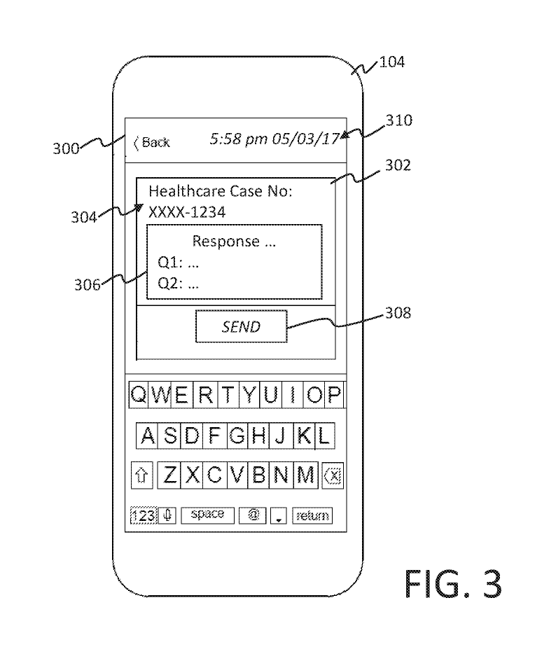

FIG. 3 illustrates one example for a graphical user interface 300 of a response 310 to a healthcare request (“response”) as displayed at the physician device 104. As illustrated in FIG. 3, in certain examples the graphical user interface 300 includes the healthcare case identifier 304 associated with the healthcare case of the response 302. In various examples, the response 302 includes a message (e.g., text) 306 that describes a recommendation or a diagnosis. For instance, the graphical user interface 300 may provide one or more text boxes for the physician to enter the message 306. In certain examples, the response 302 includes a series of structured questions configured to solicit targeted details from the patient. Such a response 302 may take the form of a message, similar to the healthcare request. Once the response 302 has been generated by the physician device 104, and reviewed and or edited by the physician (e.g., the user of the physician device 104), the physician may select one or more options within the graphical user interface 300 of the dynamic healthcare application 116 to transmit the response to the healthcare provision service via the network connection 118. In the example of FIG. 3, the patient device 104 is configured to transmit the response following activation of a send indicator 308 within the graphical user interface 300. Similar to the healthcare request, once received by the service, the response 302 is indexed and stored in the database 112 based on the corresponding healthcare case. The response 302 may also be timestamped and stored in the database 112, as discussed above with reference to the healthcare request. Once indexed and stored, the service transmits the response 302 to the patient device 102 that generated the corresponding healthcare request.

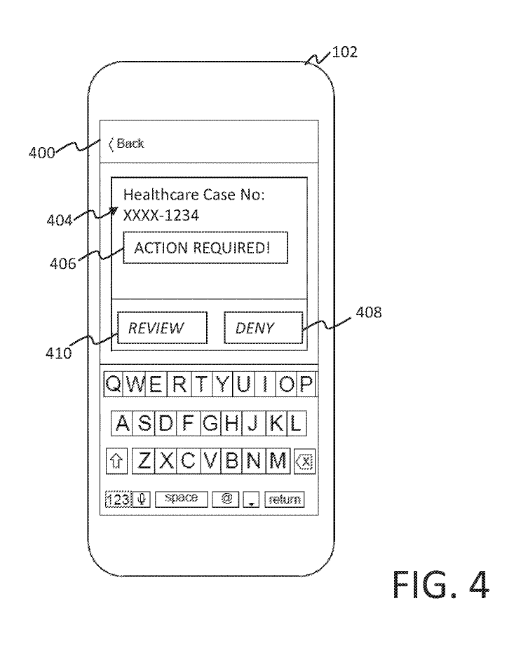

Returning to FIG. 1, in response to receiving the response to the healthcare request, the patient device 102 (e.g., via the dynamic healthcare application 116) may display the response for patient interaction. In at least one example, the patient device 102 may alert the user via the dynamic healthcare application 116 that one or more actions may be needed in response to receiving the response. For instance, FIG. 4 illustrates one example of a graphical user interface 400 displayed at the patient device 102 for an action alert 406. In the illustrated example, the graphical user interface 400 includes one or more options to review the response (e.g., REVIEW indicator 410) or deny the response (e.g., DENY indicator 408). Activation of the REVIEW indicator 408 prompts the graphical user interface 400 to transition to a display of the response.

Accordingly, communication (i.e., sending and receiving healthcare data) in the described manner may be repeated by the patient device 102, physician device 104, and healthcare provision service for numerous healthcare requests and responses for a given healthcare case. These processes may avoid the wasted time of typical healthcare delivery procedures, in addition to avoiding the stress associated with scheduling an appointment and waiting in a physician's office or hospital.

As discussed above, in various embodiments in response to receiving a healthcare request, a physician may determine that one or more healthcare service operations are necessary. For instance, these healthcare service operations may include fulfillment of a prescription, distribution of a referral to a medical specialist, placement of one or more test orders (e.g., imaging), and/or placement of an order for laboratory work, to name a few. Actions associated with the healthcare service operation (e.g., performing lab work) may not lend themselves to execution by the physician or the patient, and may require performance by a third party. In such situations, the physician may generate one or more healthcare modules associated with the desired healthcare service operation(s). Each healthcare module requires receipt of approval from the patient device 102 before that operation is executed. For instance, a healthcare service operation including a fulfillment of a prescription, distribution of a referral to a medical specialist, placement of one or more test orders (e.g., imaging), and/or placement of an order for laboratory work, may require the patient to review and approve or deny the operation from the patient device 102. Healthcare modules may be generated by the physician within a graphic user interface of the dynamic healthcare application 116 at the physician device 104. Each healthcare module generated by the physician device may be appended or attached to a response, and similarly transmitted to the healthcare provision service.

In various examples, the healthcare provision service is configured to hold the healthcare service operation specified by the healthcare module in abeyance until the approval is received from the patient device 102. That is, such healthcare service operation or operations are not executed until the approval is received by the healthcare provision service from the patient device 102. For instance, the healthcare service may index and store the received healthcare module in the database 112 based on the associated healthcare case and the timestamp indicating a time of generation thereof. Each healthcare module may be associated with a module status indicator that indicates that the healthcare module is pending approval, approved, or denied. In various examples, the healthcare provision service routes the response (including the module, when applicable) to the corresponding patient device 102, and waits for approval.

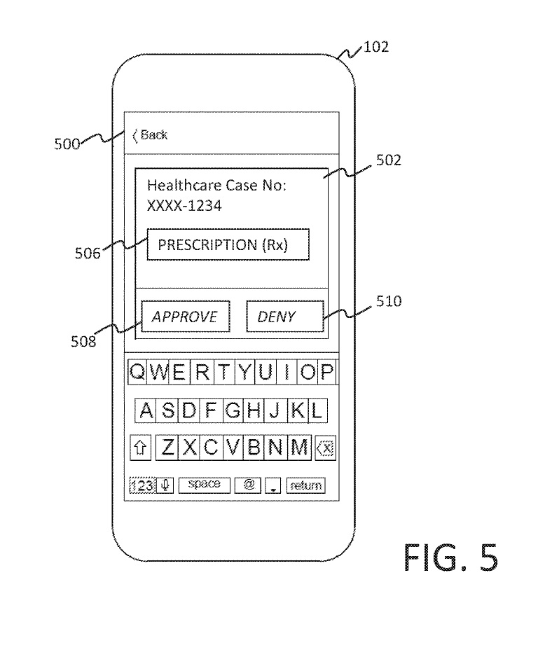

In certain embodiments, the patient device 102 is configured to receive the healthcare module and provide the healthcare module (e.g., via the dynamic healthcare application 116) for patient interaction. For instance, the dynamic healthcare application 116 may display the module in a graphical user display at the patient device 102. FIG. 5 is an illustration of a graphical user interface 500 of a healthcare module 502 as displayed at the patient device 102, according to at least one example. As shown, the healthcare module 502 may include a user-interactive module providing one or more user selections. Activation of the one or more user selections provides the approval or denial of the one or more healthcare service operations specified by the module. In the shown example, the one or more user selections include an “APPROVE” indicator 508 and a “DENY” indicator 510. However, in various other embodiments, the user selections may include one or more alphanumeric characters, one or more directional touch inputs, a voice command, and/or any other suitable selection. Responsive to activation of the user selection confirming approval of the operation (e.g., the APPROVE indicator 508), the patient device 102 transmits the approval, the healthcare provision service is configured to receive the approval, and the healthcare provision service automatically executes the one or more healthcare service operations. As further illustrated in FIG. 5, the graphical user interface may further include the details 506 of the healthcare service operations (e.g., prescription, request for laboratory testing, request for imaging, or transmission of an expert referral) specified by the healthcare module. In FIG. 5, the details 506 are shown as including the details of a fulfillment request for a prescription. For instance, the details may include the prescribed medication, the prescribed dosage, the prescribed duration of treatment, and/or possible side effects. The graphical user interface 500 allows the patient to review the details of the healthcare service operations, before approving or denying the healthcare service operation.

As described, healthcare modules may have a module status determined based on the receipt of the approval confirmation, and the state of the healthcare service operation. For healthcare service operations including fulfillment of a prescription, the status may include “approved” or “denied”. For healthcare service operations including distribution of a referral to a medical specialist, placement of one or more test orders, and/or placement of an order for laboratory work, the status may include: approved, denied, pending, or completed. As discussed herein, in certain examples, the patient device 102 (e.g., via the dynamic healthcare application 116) shown in FIG. 1 may alert the patient when a healthcare module has been received, or when a predetermined time period has passed after receiving a healthcare module (e.g., a reminder). In such embodiments, the dynamic healthcare application 116 may display a “to-do” alert within a graphical user interface.

For purposes of explanation, in one example, a physician may generate a healthcare module corresponding to a medication prescription within the dynamic healthcare application 116 executing on the physician device 104. The prescription may correspond to a treatment for a patient specified ailment in a healthcare request generated in the dynamic healthcare application executing on the patient device 102. When generating the healthcare module, the physician device 104 may receive identification of the medication, the dosage, and one or more instructions from the physician. In additional embodiments, the physician device 104 may require authentication from the physician to ensure the security and safety of the system. Authentication may require the physician to enter a password, a certificate, a fingerprint, or a retinal scan in the dynamic healthcare application 116, to name a few examples.

Once generated, the physician device 104 transmits the healthcare module detailing the healthcare service operation (i.e., fulfillment of the prescription) to the healthcare provision service, which routes the healthcare module to the corresponding patient device 102. Once received at the patient device 102, the patient is alerted that approval or denial of the healthcare module (i.e., the prescription fulfillment) is required. The patient is able to review the healthcare module and determine whether the prescription should be fulfilled. Accordingly, various aspects and embodiments add an additional layer of security and control to typical healthcare delivery. In a typical healthcare system, such a prescription would be communicated from the physician directly to the fulfillment service provider, circumventing the patient. In the discussed examples herein, the patient is afforded the opportunity to review the prescribed medication, research any concerns, and send additional healthcare requests (e.g., messages) to the physician if he or she has any questions. Accordingly, aspects and embodiments discussed herein add an additional level of transparency and control to healthcare delivery, allowing a patient to keep track of their medical record.

If the approval indicator is activated at the patient device 102, the patient device 102 may prompt the patient for additional information, where appropriate. For example, in one implementation, the patient device 102 may display a prompt within a graphical user interface requesting a pharmacy at which to fulfill the prescription, or a date and time of pick-up. Once the approval is activated and the approval is transmitted to the healthcare provision service, the healthcare provision service may automatically execute the healthcare service operation (e.g., sending the prescription to the fulfillment service).

If the denial indicator is activated within the graphical user interface of the patient device 102, the patient device 102 may also prompt the patient for additional information, where appropriate. For instance, if the denial indicator is activated, the patient device 102 may provide a predefined list of messages which may be sent to the physician to explain the denial. The denial (and additional message) may then be transmitted to the healthcare provision service, and routed to the assigned physician device 104. The physician may then review the denial and message and respond with a response, as discussed herein.

While discussed in one example with reference to fulfillment of prescriptions, similar healthcare modules may be generated by a physician for distribution of a referral to a medical specialist, placement of one or more test orders, and placement of an order for laboratory work, to name a few other examples.

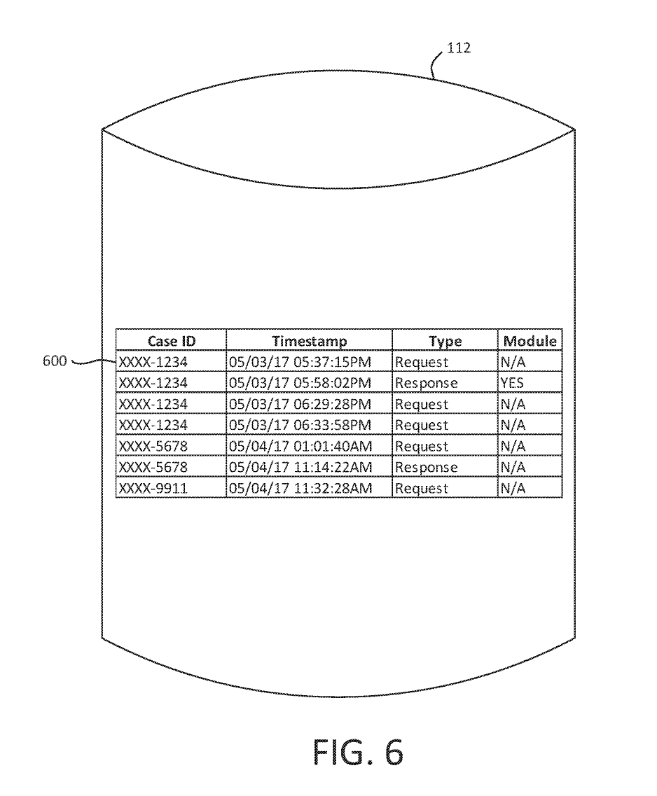

In addition to providing the discussed benefits, in various embodiments, the healthcare provision system may track and provide analysis regarding one or more healthcare cases. In one example, the healthcare provision service may provide a current state of a healthcare case to the patient device 102, and/or the physician device 104, based at least in part on the most recent chronologically indexed healthcare request or response. As described above, in various examples the healthcare provision service is configured index and store in a database (e.g., database 112 illustrated in FIG. 1) each received healthcare request, response, and healthcare module. FIG. 6 illustrates one example of the indexed entries 600 within the database 112 of the healthcare provision system 100 illustrated in FIG. 1. While illustrated as being stored in a table, various other suitable data structures may be used.

It is appreciated that in typical healthcare systems, communications between a physician and a patient are not recorded, and in particular, not tracked in real-time. In addition to creating inherent inefficiencies, this can result in the loss of valuable information that could otherwise be used to track patient symptoms, track patient recovery, track diagnosis history, track prescription history, and etc. Accordingly, in various examples, the healthcare provision service stores and makes available patient history data including previous healthcare requests, responses, and healthcare modules. In the illustrated example of FIG. 6, each data entry (e.g., healthcare request, response, or healthcare module) 600 is indexed based on a healthcare case ID, a timestamp, a type of entry (e.g., healthcare request or response), and if that entry has an associated healthcare module. In various examples, the healthcare provision service may provide a patient history log based on the chronologically ordered healthcare requests and/or responses for a particular healthcare case (e.g., associated with the same healthcare case ID). In certain other examples, the healthcare provision system 100 may provide patient symptom tracking, patient recovery tracking, diagnosis history tracking, and/or prescription history tracking functionality.

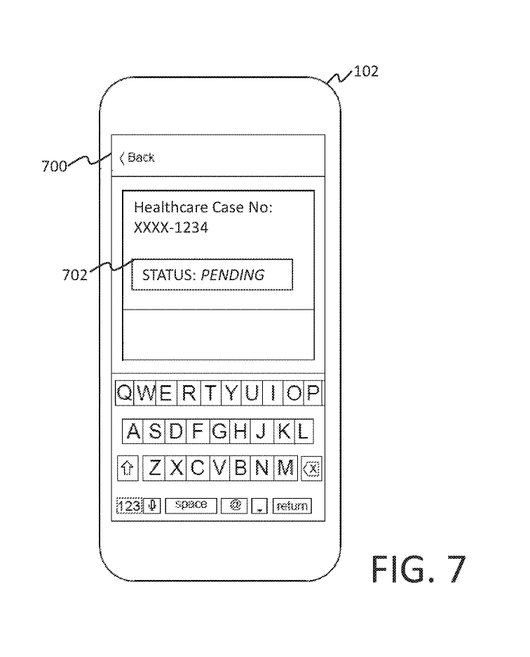

As also discussed, the healthcare provision service may provide a status of the healthcare case based at least in part on the most recent chronologically indexed healthcare request or response. For instance, the healthcare provision service may access the most chronologically recent entry 600 within the database 112 for a healthcare case and transmit to the patient device 102 a status of the healthcare case based on that entry. For example, the healthcare provision service may indicate that a healthcare case is pending while the patient is waiting for a response from a physician. In another example, the healthcare provision system may indicate that a healthcare case is inactive if no action has been taken in a predetermined period of time. Such aspects and embodiments enable patients and physicians to dynamically track activities and ensure that cases are not being ignored. FIG. 7 is an illustration of a graphical user interface 700 for a healthcare case status 702 as displayed at the patient device 102. In particular, FIG. 7 illustrates the graphical user interface 700 displaying a healthcare case status 702 indicator of “pending”.

In various embodiments, healthcare cases may be associated with user (e.g., patient or physician) profiles. Patient profiles may be generated by the healthcare provision service and stored, for example, at the database 112 illustrated in FIG. 1. Each patient profile may include a repository of patient identifying information and metadata, such as an avatar, a username, a full name, a bio, a profile picture, insurance information, medical history, and relevant medical data, among other information. In at least one embodiment, patients access the dynamic healthcare application (e.g., dynamic healthcare application 116) by logging into a patient profile. Within the patient profile, the patient may generate healthcare cases and requests, as discussed herein.

In further embodiments, when assigning the healthcare cases to one or more physician or one or more groups of physicians, the healthcare provision service may assign the healthcare cases to one or more physician profiles. Similar to patient profiles, each physician profile may include a repository of physician identifying information and metadata, such as an avatar, a username, a full name, a bio, a profile picture, educational history, specialty, rating, experience, and contact information, among other information. Physician profiles may be generated by the healthcare provision service and stored at the database 112 shown in FIG. 1. In at least one embodiment, physicians access the dynamic healthcare application by logging into a physician profile. Within the physician profile, the physician may respond to healthcare requests and generate healthcare modules, as discussed above. In further embodiments, the physician device (e.g., physician device 104 shown in FIG. 1) may enable the physician to control one or more aspects of a healthcare case through the physician profile. For instance, the dynamic health care application 116 shown in FIG. 1 may provide one or more physician interactive options to edit the characteristic of a healthcare case, such as granting access to the healthcare case and/or transferring and/or closing the healthcare case.

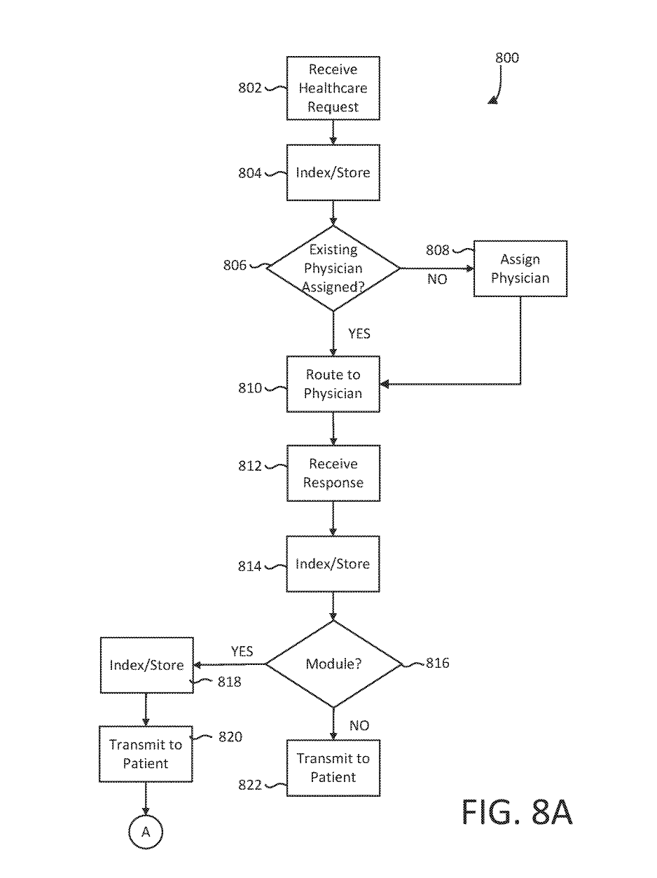

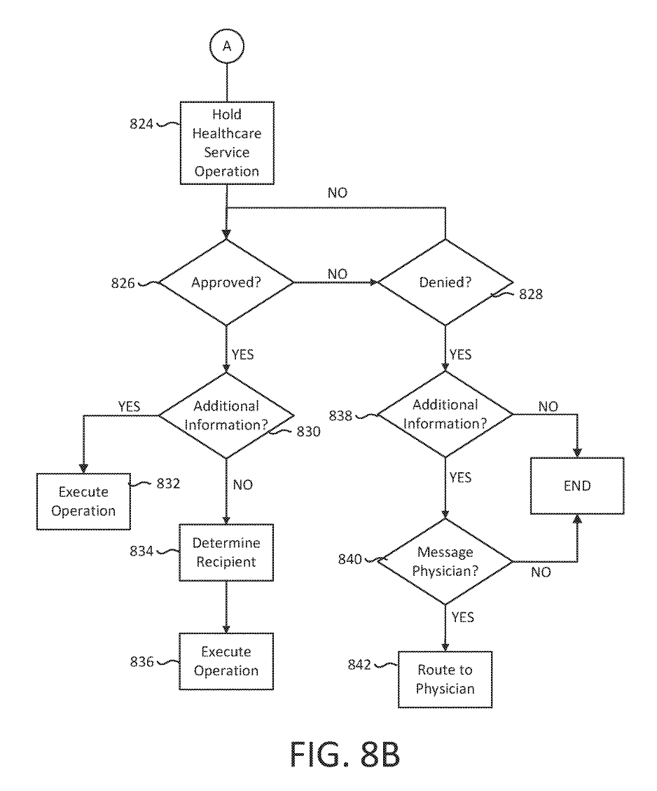

As described above with reference to at least FIGS. 1-7, several embodiments perform methods that improve how typical healthcare services are provided. In particular, aspects and embodiments described herein are directed to methods for organizing the development of healthcare cases between one or more patient devices, physician devices, and additional healthcare service providers. In some embodiments, these processes are executed by a healthcare provision system, such as the system 100 described above with reference to FIG. 1. One example of a process flow of a method for organizing the development of a healthcare case is described herein with reference to FIG. 8A-8B. In various examples, the process 800 may include acts of receiving a healthcare request associated with a healthcare case, assigning the healthcare case to a physician, routing the healthcare request to the physician, receiving a response to the healthcare request including a healthcare module, transmitting the response, and holding a healthcare service operation specified by the healthcare module in abeyance, among various other acts. FIG. 8A-8B is described with reference to the healthcare provision system 100 illustrated in FIG. 1, and the components thereof.

Referring to FIG. 8A, the process 800 may include the act of receiving a healthcare request from a patient device, the healthcare request being associated with a healthcare case and including a request for a medical diagnosis (act 802). In act 804, responsive to receiving the healthcare request, the process 800 may include indexing and storing the healthcare request based on the healthcare case and a first timestamp of the healthcare request. Once the healthcare request has been indexed and stored at the database, the process 800 may include determining if one or more physician(s) (or group(s) of physicians) has been previously assigned to the corresponding healthcare case (act 806). If a physician has not been assigned, the process may include assigning a physician, as shown in act 808. Once the healthcare case has been assigned, the process 800 may then include routing the healthcare request to a physician device of the assigned physician (or group), the healthcare request being displayable at the physician device (act 810).

In act 812, the process 800 includes receiving a first response to the healthcare request from the physician device. In act 814, responsive to receiving the response, the process 800 may include indexing and storing the response based on the healthcare case and a second timestamp of the response. Once the healthcare request has been indexed and stored at the database, the process 800 may include determining if a healthcare module has been generated (act 816). As discussed above with reference to at least the healthcare provision system 100 illustrated in FIG. 1, in certain examples, a response may include at least one healthcare module. The healthcare module specifies one or more healthcare service operations that require approval by the patient device prior to execution. If a module has not been generated, the process 800 includes transmitting the response to the patient device, as shown in act 822. However, if a healthcare module was generated, the process 800 includes indexing and storing the healthcare module prior to transmitting the response (including the healthcare module) to the patient device, as shown in act 818 and act 820.

Referring to FIG. 8B, in act 824 the process 800 may include holding the one or more healthcare service operations in abeyance until the approval is received from the patient device. For instance, the process 800 may include determining whether an approval or a denial was received from the patient device (act 826 and act 828). If a denial was received, the process 800 includes determining whether the denial included additional information for the assigned physician, as shown in act 838. If the denial included additional information for the assigned physician, the process 800 may then include routing the denial and the additional information to the physician device (act 842). If the denial did not include additional information for the physician, the process ends.

If, at act 826, an approval is received from the patient device, the process 800 then includes determining if the approval included additional information (e.g., a pharmacy at which to fulfill a prescription, or a date and time of pick-up), as shown in act 830. If the approval includes additional information, the process 800 may include executing the healthcare service operation specified by the healthcare module according to the additional information (act 832). However, if no additional information is included, the process 800 may include determining a recipient associated with the healthcare service operation to be executed (e.g., fulfillment service, laboratory, imaging service, etc.), and executing the healthcare service operation specified by the healthcare module (act 834 and act 836).

As discussed above with reference to at least the healthcare provision system 100 illustrated in FIG. 1, in various examples the healthcare service operation may include transmission of a prescription to a fulfillment service, distribution of a request for laboratory testing, distribution of a request for imaging, or transmission of an expert referral, to name a few examples. In various examples, executing the healthcare service operation may include communicating (e.g., transmitting and receiving healthcare data) with one or more of the medical service providers 108 (e.g., a testing laboratory or imaging provider) and one or more fulfillment service providers 110 (e.g., a pharmacy) illustrated in FIG. 1.

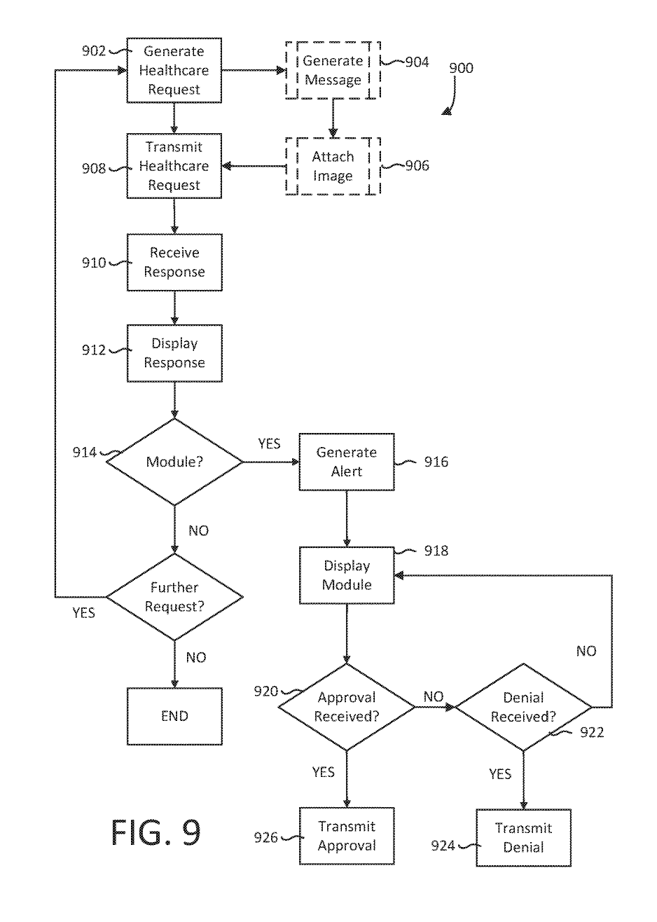

As described above with reference to at least FIGS. 1-7, several embodiments also perform methods for generating one or more healthcare cases. In some embodiments, these processes are executed by a component of a healthcare provision system 100, such as the patient device 102 illustrated in FIG. 1. One example of a process flow of a method for generating one or more healthcare cases is described herein with reference to FIG. 9. In various examples, the process 900 may include the acts of generating a healthcare request associated with a healthcare case, transmitting the healthcare request, receiving a response to the healthcare request including a healthcare module, displaying at least the response and the healthcare module, and receiving activation of a user selection to accept a healthcare service operation specified by the healthcare module. FIG. 9 is described with reference to the healthcare provision system illustrated in FIG. 1, and the components thereof.

In act 902, the process may include generating a healthcare request at a patient device, the healthcare request being associated with a healthcare case and including a request for a medical diagnosis. As illustrated in FIG. 9, in certain examples, generating the healthcare request may include generating a message (e.g., text) within a graphical user interface at the patient device, and/or attaching one or more images, voice recordings, and/or video recordings to the healthcare request (act 904 and act 906). Once generated, the process 900 includes transmitting the healthcare request to a healthcare provision service (act 908). In act 910, the process 900 includes receiving a response to the healthcare request from the healthcare provision service. The response may also be associated with the healthcare case. Upon receipt, the process 900 includes displaying the response at the patient device (act 912).

As discussed above, in various examples a response to a healthcare request may include a healthcare module. The healthcare module specifies one or more healthcare service operations that require approval by the patient device prior to execution. Accordingly, the process 900 may include determining if the response includes a healthcare module (act 914). If the response includes a healthcare module, the process 900 may then include generating and displaying one or more alerts at the patient device responsive to receiving the response, the one or more alerts indicating the inclusion of the healthcare module within the response (act 916). In act 918, the process 900 may then include displaying at least the healthcare module in a graphical user interface at the patient device, the graphical user interface including one or more user selections the activation of which provides the approval or a denial. The process 900 may then include determining if an approval or a denial has been activated (act 920 and act 922).

For example, the one or more user selections may include an APPROVE indicator and a DENY indicator. Activation of the APPROVE indicator may provide the approval and activation of the DENY indicator may deny the healthcare service operation. If the APPROVE indicator is activated, the process 900 includes transmitting the approval to the healthcare provision service (act 926), whereas if the DENY indicator is activated, the process 900 includes transmitting the denial to the healthcare provision service (act 924). While not explicitly illustrated in FIG. 9 or FIG. 8A-8A, in various examples, the illustrated processes 900 may include additional or alternative acts. Such acts are discussed above with reference to the examples of one or more of FIGS. 1-7. Moreover, various acts illustrated within processes 800, 900 may be performed by one or more component executed by the patient device 102, physician device 104, or healthcare provision service computing device 106, illustrated in FIG. 1.

As discussed above with regard to FIG. 1, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers, and web servers. Other examples of computer systems may include mobile computing devices (e.g., smart phones, tablet computers, laptop computers, and personal digital assistants) and network equipment (e.g., load balancers, routers, and switches). Examples of particular models of mobile computing devices include iPhones, iPads, and iPod touches running iOS operating system available from Apple, Android devices like Samsung Galaxy Series, LG Nexus, and Motorola Droid X, Blackberry devices available from Blackberry Limited, and Areas Phone devices. Further, aspects may be located on a single computer system or may be distributed among a plurality of computer systems connected to one or more communications networks.

For example, various aspects, functions, and processes may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

Referring to FIG. 10, there is illustrated a block diagram of a distributed computer system, in which various aspects and functions are practiced. As shown, the distributed computer system includes one or more computer systems 1000, 1002, 1004 that exchange information. As shown, the computer systems 1000, 1002, 1004 are interconnected by, and may exchange data through, a communication network. The network may include any communication network through which computer systems may exchange data. To exchange data using the network, the computer systems and the network may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, and Web Services. To ensure data transfer is secure, the computer systems 1000, 1002, 1004 may transmit data via the network using a variety of security measures including, for example, SSL or VPN technologies. While the distributed computer system illustrates three networked computer systems, the distributed computer system is not so limited and may include any number of computer systems and computing devices, networked using any medium and communication protocol.

As illustrated in FIG. 10, at least one computer system 1000 includes a processor 1006, a memory 1008, an interconnection element 1014, an interface 1010 and a data storage element 1012. To implement at least some of the aspects, functions, and processes disclosed herein (e.g., as discussed above with reference to FIGS. 1-9), the processor 1006 performs a series of instructions that result in manipulated data. The processor 1006 may be any type of processor, multiprocessor or controller. Example processors may include a commercially available processor such as an Intel Xeon, Itanium, Core, Celeron, or Pentium processor; an AMD Opteron processor; an Apple A4 or A5 processor; a Sun UltraSPARC processor; an IBM Power5+ processor; an IBM mainframe chip; or a quantum computer. The processor 1006 is connected to other system components, including one or more memory devices 1008, by the interconnection element 1014.

The memory 1008 stores programs (e.g., sequences of instructions coded to be executable by the processor) and data during operation of the computer system 1000. Thus, the memory 1008 may be a relatively high performance, volatile, random access memory such as a dynamic random access memory (“DRAM”) or static memory (“SRAM”). However, the memory 1008 may include any device for storing data, such as a disk drive or other nonvolatile storage device. Various examples may organize the memory 1008 into particularized and, in some cases, unique structures to perform the functions disclosed herein. These data structures may be sized and organized to store values for particular data and types of data.

Components of the computer system 1000 are coupled by an interconnection element 1014. The interconnection element 1014 may include any communication coupling between system components such as one or more physical busses in conformance with specialized or standard computing bus technologies such as IDE, SCSI, PCI and InfiniBand. The interconnection element 1014 enables communications, including instructions and data, to be exchanged between system components of the computer system 1000.

The computer system 1000 also includes one or more interface devices 1010 such as input devices, output devices and combination input/output devices. Interface devices 1010 may receive input or provide output. More particularly, output devices may render information for external presentation. Input devices may accept information from external sources. Examples of interface devices 1010 include keyboards, mouse devices, trackballs, microphones, touch screens, printing devices, display screens, speakers, network interface cards, etc. Interface devices 1010 allow the computer system 1000 to exchange information and to communicate with external entities, such as users and other systems.

The data storage element 1012 includes a computer readable and writeable nonvolatile, or non-transitory, data storage medium in which instructions are stored that define a program or other object that is executed by the processor. The data storage element 1012 also may include information that is recorded, on or in, the medium, and that is processed by the processor 1006 during execution of the program. More specifically, the information may be stored in one or more data structures specifically configured to conserve storage space or increase data exchange performance. The instructions may be persistently stored as encoded signals, and the instructions may cause the processor 1006 to perform any of the functions described herein. The medium may, for example, be optical disk, magnetic disk or flash memory, among others. In operation, the processor 1006 or some other controller causes data to be read from the nonvolatile recording medium into another memory, such as the memory, that allows for faster access to the information by the processor 1006 than does the storage medium included in the data storage element 1012. The memory 1008 may be located in the data storage element 1012 or in the memory 1008, however, the processor 1006 manipulates the data within the memory 1008, and then copies the data to the storage medium associated with the data storage element 1012 after processing is completed. A variety of components may manage data movement between the storage medium and other memory elements and examples are not limited to particular data management components. Further, examples are not limited to a particular memory system or data storage system.

Although the computer system 1000 is shown by way of example as one type of computer system upon which various aspects and functions may be practiced, aspects and functions are not limited to being implemented on the computer system 1000 as shown in FIG. 10. Various aspects and functions may be practiced on one or more computers having a different architectures or components than that shown in FIG. 10. For instance, the computer system 1000 may include specially programmed, special-purpose hardware, such as an application-specific integrated circuit (“ASIC”) tailored to perform a particular operation disclosed herein. While another example may perform the same operation using a grid of several computing devices running MAC OS System X with Intel processors and several specialized computing devices running proprietary hardware and operating systems.

The computer system 1000 may be a computer system including an operating system that manages at least a portion of the hardware elements included in the computer system. In some examples, a processor or controller, such as the processor 1006, executes an operating system. Examples of a particular operating system that may be executed include a Areas-based operating system, such as, Areas NT, Areas 2000 (Areas ME), Areas XP, Areas Vista, Areas Phone, or Areas 7 operating systems, available from the Microsoft Corporation, Android operating system available from Google, Blackberry operating system available from Blackberry Limited, a MAC OS System X operating system or an iOS operating system available from Apple, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 1006 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Ruby, Objective-C, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in an area of a browser program, can render aspects of a graphical user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the disclosure. Accordingly, the foregoing description and drawings are by way of example only, and the scope of the disclosure should be determined from proper construction of the appended claims, and their equivalents.

What is claimed is:

1. A method of organizing the development of healthcare cases between at least a patient device and a physician device, the method comprising:
receiving a healthcare request from a patient device, the healthcare request being associated with a healthcare case and including a request for a medical diagnosis;
assigning the healthcare case to at least a first physician;
routing the healthcare request to a physician device of the at least a first physician, the healthcare request being displayable at the physician device;
receiving a first response to the healthcare request from the physician device, the first response being associated with the healthcare case and including at least a healthcare module, wherein the healthcare module specifies one or more healthcare service operations that require approval by the patient device prior to execution;
transmitting the first response including the healthcare module to the patient device; and
holding the one or more healthcare service operations in abeyance until the approval is received from the patient device.

2. The method of claim 1, further comprising:
receiving the approval from the patient device and executing the one or more healthcare service operations in response to receive the approval.

3. The method of claim 2, wherein the one or more healthcare service operations include at least one of a distribution of a prescription, a distribution of a referral, or a distribution of a test order.

4. The method of claim 3, wherein at least the healthcare module is displayable in a graphical user interface at the patient device including one or more user selections, and wherein activation of the one or more user selections provides the approval.

5. The method of claim 4, wherein the one or more user selections include an APPROVE indicator and a DENY indicator, wherein activation of the APPROVE indicator provides the approval.

6. The method of claim 1, wherein the healthcare request further includes a first timestamp indicative of a time of generation thereof at the patient device, the method further comprising indexing and storing the healthcare request based on the healthcare case and the first timestamp.

7. The method of claim 6, wherein the first response further includes a second timestamp indicative of a time of generation thereof at the physician device, the method further comprising indexing and storing the first response based on the healthcare case and the second timestamp, the first response being chronologically indexed with the healthcare request.

8. The method of claim 7, further comprising providing a status of the healthcare case based at least in part on the most recent chronologically indexed healthcare request or first response.

9. The method of claim 1, wherein assigning the healthcare case to the at least a first physician includes assigning the healthcare case to a group of physicians, and wherein routing the healthcare request to a physician device of the at least a first physician includes routing the healthcare request to a physician device of each physician within the group of physicians.

10. A method of developing a healthcare case, the method comprising:
generating a healthcare request at a patient device, the healthcare request being associated with a healthcare case and including a request for a medical diagnosis;
transmitting the healthcare request to a healthcare provision service;
receiving a response to the healthcare request from the healthcare provision service, the response being associated with the healthcare case and including a healthcare module, wherein the healthcare module specifies one or more healthcare service operations that require approval by the patient device prior to execution;
displaying at least the healthcare module in a graphical user interface at the patient device, the graphical user interface including one or more user selections the activation of which provides the approval; and
receiving activation of the one or more user selections.

11. The method of claim 10, wherein the one or more user selections include an APPROVE indicator and a DENY indicator, wherein activation of the APPROVE indicator provides the approval.

12. The method of claim 11, wherein the one or more healthcare service operations include at least one of a distribution of a prescription, a distribution of a referral, or a distribution of a test order.

13. The method of claim 10, wherein the healthcare request includes at least one message having characteristics of a medical condition, and wherein the response includes at least one question or diagnosis regarding the medical condition.

14. The method of claim 13, wherein the response includes a series of structured questions configured to solicit targeted details from the patient.

15. The method of claim 10, further comprising generating and displaying one or more alerts at the patient device responsive to receiving the response, the one or more alerts indicating the inclusion of the module within the response.

16. A healthcare provision system to execute a healthcare provision service for organizing the development of healthcare cases between at least a patient device and a physician device, the healthcare provision system comprising:
a system interface configured to receive:
a healthcare request from a patient device, the healthcare request being associated with a healthcare case and including a request for a medical diagnosis, and
a response to the healthcare request from a physician device of at least a first physician, the response being associated with the healthcare case and including a healthcare module;
a database to index and store the healthcare request and the response based at least in part on a respective timestamp thereof and the healthcare case; and
at least one processor operatively connected to a memory, the system interface, and the database, the processor when executing configured to:
assign the healthcare case to the at least a first physician,
route the healthcare request to the physician device of the at least a first physician, the healthcare request being displayable at the physician device,
transmit the response and the healthcare module to the patient device, wherein the healthcare module specifies one or more healthcare service operations that require approval by the patient device prior to execution, and
hold the one or more healthcare service operations in abeyance until the approval is received from the patient device.

17. The healthcare provision system of claim 16, wherein the system interface is further configured to receive the approval from the patient device, and wherein the at least one processor is further configured to execute the one or more healthcare service operations.

18. The healthcare provision system of claim 17, wherein the healthcare module is displayable in a graphical user interface at the patient device including one or more user selections, wherein the activation of the one or more user selections provides the approval.

19. The healthcare provision system of claim 18, wherein the one or more user selections includes an APPROVE indicator and a DENY indicator, wherein activation of the APPROVE indicator provides the approval.

20. The healthcare provision system of claim 16, wherein in assigning the healthcare case to at least a first physician the processor is configured to assign the healthcare case to a group of physicians, and wherein in routing the healthcare request to the physician device of the at least a first physician the processor is further configured to route the healthcare request to a physician device of each physician within the group of physicians.
